(19) United States
(12) Patent Application Publication
(10) Pub. No.: US 2011/0044866 A1
(43) Pub. Date: Feb. 24, 2011

(54) Method and Apparatus for Processing Substances in a Single Container

(76) Inventor: Norman Binz DeWalch, Houston, TX (US)

Correspondence Address: DeWalch Technologies, Inc., 6850 Wynnwood Lane, Houston, TX, 77008, US

(21) Appl. No.: 12/840,268

(22) Filed: Jul. 20, 2010

Related U.S. Application Data
(63) Continuation of application No. 12/006,571, filed on Jan. 2, 2008, now abandoned.
Application No. 12/006,571 is a continuation-in-part of application No. 10/641,378, filed on Aug. 13, 2003, now abandoned.
Application No. 10/641,378 is a continuation of application No. 09/658,017, filed on Sep. 12, 2000, now abandoned.
Application No. 09/658,017 is a continuation-in-part of application No. 09/532,599, filed on Mar. 22, 2000, now abandoned.

(51) Int. Cl. B01D 35/00

(52) U.S. Cl. 422/534

(57) ABSTRACT

In one example embodiment of the present invention, a vessel having an open end and a closed end is provided. The vessel further includes, but is not limited to, a filtering substance. The filtering means is disposed generally toward the closed end of the vessel. Subsequently the closed end of the tube or vessel can be pierced so that the liquid and waste products can be removed from the vessel through the pierced aperture. In another example embodiment, a method for processing at least one substance in a vessel capable of retaining at least one substance is provided. The method includes, but is not limited to, introducing the at least one substance into the vessel. The method further comprises processing the at least one substance. The method further includes, but is not limited to, creating an aperture in the vessel; and removing at least one substance through the aperture.

### CROSS-REFERENCE TO RELATED APPLICATIONS

This application is a continuation of U.S. application Ser. No. 12/006,571, filed Jan. 2, 2008, which is a continuation-in-part of U.S. application Ser. No. 10/641,378, filed Aug. 13, 2003, now abandoned, which is a continuation of U.S. application Ser. No. 09/658,017, filed Sep. 12, 2000, now abandoned, which is a continuation-in-part of U.S. application Ser. No. 09/532,599, filed Mar. 22, 2000, now abandoned, to which the instant application claims priority.

The instant application claims priority to each of the above-referenced applications as noted above. All written material, figures, content and other disclosure in each of the above-referenced applications and the following applications to the fullest extent permitted are hereby incorporated by reference: International Application No. PCT/US2001/09090, filed Mar. 21, 2001; Indian Patent Application No. IN/PCT/2002/01197, filed Sep. 23, 2003, now Indian Patent No. 199293, dated Mar. 21, 2001; Indian Patent Application No. 1077/KOL/2005, filed Nov. 25, 2005.

### FIELD OF INVENTION

The present invention relates in general to the processing of substances and specifically to a method and apparatus for processing substances in a single container.

### BACKGROUND OF INVENTION

Recent research initiatives have spawned an increased effort to streamline the various processes, such as for example DNA sequencing. Current protocols for purifying nucleic acid samples for sequencing include a centrifugation step, which is used to precipitate the solids from a sample substance containing the target nucleic acid and a number of waste products. Because this step must be accomplished without the loss of the sample, the centrifugation must be performed in a sample container which is completely sealed at the bottom.

Many of these protocols also include a filtration step, wherein the sample substance containing the nucleic acid and waste products is passed through a filtering means. The filter material selectively binds to the target nucleic acid, while allowing the liquid and waste products to flow through. Because it is necessary to remove the waste products and liquid after filtration, this step must be performed in a sample container which already includes an opening below the filtering means. Examples of such containers are shown in U.S. Pat. Nos. 4,683,058 (1987, Lyman et al.), 5,264,184 (1993, Aysta et al.), and 5,910,246 (1999, Walter et al.); the teachings of which are incorporated by reference.

Since the container requirements for these two steps are incompatible, the sample must be transferred from the closed container (used for centrifugation) to the container which includes the opening (used for the filtration step), which adds a step to the overall process. Furthermore, the closed containers (usually plastic test tubes) are discarded after the transfer. If the same container or test tube could be used for both the centrifugation and filtration steps, the time consuming transfer step could be eliminated, and the amount of solid waste generated could be reduced. Therefore, there is a long felt need for a method and apparatus for processing substances in a single container.

The sequencing of DNA has long been relegated to the controlled environment of the research laboratory. In order to ensure high quality data, current laboratory protocols implement many precise, manual operations which could only be performed by skilled technicians. Although numerous mechanical devices exist to perform some of these individual operations, the overall number of operations remains large, and each of these devices still require skilled supervision. Furthermore, each additional step in the process is a potential source of error. A particularly time consuming part of the sequencing process is the isolation and purification of DNA templates from the bacterial cultures in which the DNA is cloned. Many existing methods for DNA template preparation have been adapted to the standard 96-well format, in which samples are batch processed in trays or plates, each containing 96 tubes or sample wells. One such method is disclosed in Anderson et al., Method for 96-well M13 DNA Template Preparations for Large-Scale Sequencing, BioTechniques (June 1996). Another example of such a method is disclosed in QIAprep 96 M13 Protocol, QIAprep M13 Handbook (2/99) from Qiagen Incorporated. These references are herein incorporated by reference.

Recent research initiatives have created great demand for large-scale, high-speed techniques for sequencing and mapping genetic material. Although several integrated machines have been developed which automate of some or all of the template preparation process, these machines usually duplicate the manual operations of the previous methods without seeking to eliminate or consolidate steps. Furthermore, many of these methods require the use of expensive and highly specialized sample containers, which essentially have no other uses except as disclosed. Methods of this type are disclosed in U.S. Pat. Nos. 5,610,074 (Beritashvili et al., 1997) and 5,863,801 (Southgate et al., 1999), incorporated herein by reference. Thus, there is long felt need for a method or apparatus for processing substances in a single container.

Those of skill in the art will appreciate the example embodiments of the present invention which addresses the above needs and other significant needs the solution to which are discussed hereinafter.

### SUMMARY OF THE INVENTION

In one example embodiment, a method for processing at least one substance in a vessel capable of retaining at least one substance is provided. The method comprises introducing the at least one substance into the vessel. The method further comprises processing the at least one substance. The method further comprises creating an aperture in the vessel, and removing at least one substance through the aperture.

In another example embodiment of the present invention, a vessel having an open end and a closed end is provided. The vessel further comprises a filtering means. The filtering means is disposed generally toward the closed end of the vessel. Subsequently the closed end of the vessel can be pierced so that the liquid and waste products can be removed from the vessel through the pierced aperture.

In an even further example embodiment, an improved method for processing substances in a single container is provided. One example embodiment is directed toward preparing DNA templates from bacterial cultures. The method comprises inserting a glass fiber filter into a standard plastic tube to create a tube or vessel. The method further comprises adding a PEG solution to the tube or vessel. The method comprises adding M13 phage supernatant to the tube or vessel and mixing the PEG solution and the M13 phage supernatant to precipitate the phage. The method also comprises pelleting the phage by centrifugation and piercing the closed end of the tube or vessel to create an aperture. The method also comprises removing the excess fluid through the aperture by applying a vacuum to the apertured end of the tube. The method further comprises dissociating the phage proteins from the DNA by adding a sodium per-chlorate solution to the tube or vessel. The method further comprises removing the excess fluid through the aperture by applying a vacuum to the apertured end of the tube and washing the filter-bound DNA by adding an ethanol solution to the tube or vessel. The method also comprises removing the excess fluid through the aperture by applying a vacuum to the apertured end of the tube and adding a TE buffer solution to the tube or vessel. The method further comprises eluting the DNA into a collection well through the aperture by applying a positive pressure to the open end of the tube or vessel.

These and other objects, features, and advantages will become apparent from the drawings, the descriptions given herein, and the appended claims. However, it will be understood that the above-listed objectives and/or advantages are intended only as an aid in quickly understanding aspects of the invention, are not intended to limit the invention in any way, and therefore do not form a comprehensive or restrictive list of objectives, and/or features, and/or advantages.

The content and disclosure of each of the following applications/publications to the extent permitted are specifically hereby incorporated by reference: Continuation-in-part U.S. patent application Ser. No. 12/006,571, filed Jan. 2, 2008; Continuation-in-part U.S. application Ser. No. 10/641,378, filed Aug. 13, 2003; Continuation U.S. application Ser. No. 09/658,017, filed Sep. 12, 2000; Continuation-in-part U.S. application Ser. No. 09/532,599, filed Mar. 22, 2000; International Application No. PCT/US2001/09090, filed Mar. 21, 2001; Indian Patent Application No. IN/PCT/2002/01197, filed Sep. 23, 2003, now Indian Patent No. 199293, dated Mar. 21, 2001; Indian Patent Application No. 1077/KOL/2005, filed Nov. 25, 2005.

There has thus been outlined, rather broadly, features of example embodiments of the invention in order that the detailed description thereof may be better understood, and in order that the present contribution to the art may be better appreciated. There are additional features of example embodiments of invention that will be described hereinafter.

In this respect, before explaining at least one example embodiment of the invention in detail, it is to be understood that the example embodiments are not limited in its application to the details of construction and to the arrangements of the components, features, or aspects set forth in the following description or illustrated in the drawings. Various example embodiments are capable of other further embodiments and of being practiced and carried out in various ways. Also, it is to be understood that the phraseology and terminology employed herein are for the purpose of the description and should not be regarded as limiting.

To the accomplishment of the above and related objects, example embodiments of the invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the embodiments of the invention will become fully appreciated as the same becomes better understood when considered in conjunction with the accompanying drawings, and wherein:

FIG. 1 shows a cross-sectional view of an example embodiment vessel.

FIG. 2 shows a cross-sectional view of an example embodiment vessel having a flat closed end.

FIG. 3 shows a cross-sectional view of an example embodiment vessel in which the filtering means comprises beads.

FIG. 4 shows a cross-sectional view of an example embodiment vessel in which the filtering means comprises a gel or other suitable substance.

FIG. 5 shows cross-sectional view of an example embodiment vessel having a recess on the inside of the closed end.

FIG. 6 shows an example embodiment vessel in which the filtering means is offset from the closed end.

FIG. 7 shows a cross-sectional view of an example embodiment vessel having a double layer filtering means.

FIGS. 8a and 8b show isometric cutaway views of example embodiment vessels having integral supports on the inside of the closed end.

FIG. 9 shows an isometric cutaway view of an example embodiment vessel having a series of grooves on the inside of the closed end.

FIG. 10 shows an isometric view of an example vessel and filter used in an example method embodiment.

FIG. 11 shows a cross-sectional view of a vessel with a filter inserted.

FIG. 12 shows a vessel being pierced.

FIG. 13 shows fluid being drawn through an aperture under the application of a vacuum.

FIG. 14 shows a desired substance being removed under application of positive pressure.

FIG. 15 shows an example 96-well format arrangement of vessels.

FIG. 16 shows an example embodiment of a method of the present invention.

While various example embodiments of the invention will be described herein, it will be understood that it is not intended to limit the invention to those embodiments. On the contrary, it is intended to cover all alternatives, modifications, and equivalents included within the spirit of the invention.

### DETAILED DESCRIPTION OF THE INVENTION

In one example embodiment of the present invention, an apparatus for processing substances is provided. Referring to FIG. 1, the vessel or test tube 10 comprises a hollow cylindrical body 12 having an open end 14 and a spherical closed end 16. In an example embodiment, the test tube or vessel 10 is made of a thermoplastic material. In other embodiments, any suitable material and any suitable shape that will occur to those of ordinary skill in the art is used. The filtering means 20 comprises a disc of glass fiber paper, which is inserted into test tube until the paper conforms to the shape of the closed end of the vessel. In alternative embodiments the filter means may comprise any suitable material which selectively and releasably retains a desired substance from a sample substance. In alternate embodiments, these filter means are beads—such as glass beads and microspheres, such as those sold by Bangs Laboratories, Inc. to name just a few—granular substances, gels, silica gels, solid substrates, chemical treatments to the vessel, or any other filter means that will occur to those of ordinary skill in the art.

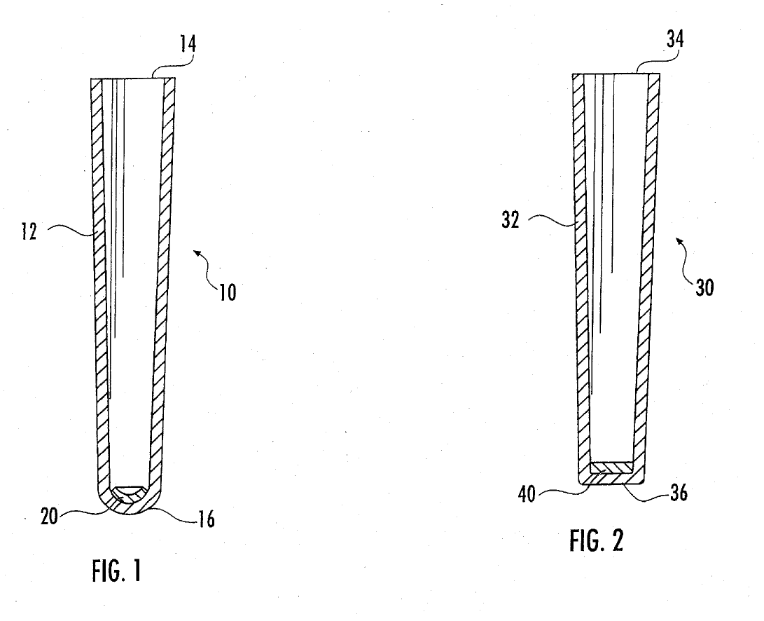

Referring to FIG. 2, an alternative embodiment test tube 30 comprises a cylindrical body 32 having an open end 34 and a flattened closed end 36. The filtering means 40 remains flat when it is fully inserted into the test tube. FIG. 3 shows an alternative embodiment vessel or test tube 44 in which the filtering means 46 comprises a plurality of glass beads. FIG. 4 shows an alternative embodiment test tube 50 in which the filtering means 52 comprises a gel. In various embodiments, this gel comprises a silica gel or any other gel that will occur to those of ordinary skill in the art.

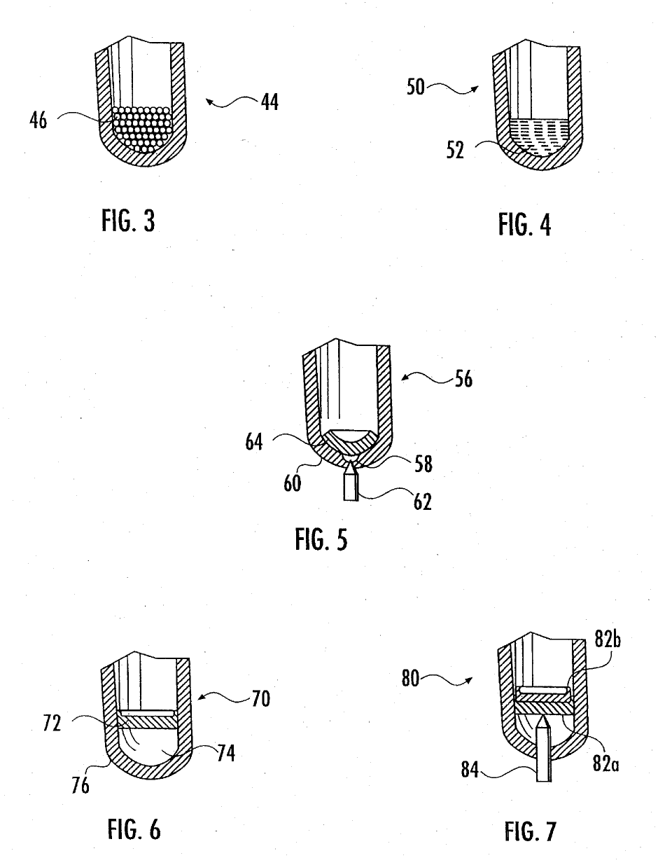

Referring to FIG. 5, an alternative embodiment test tube or vessel 56 includes a hemispherical recess 58 disposed on the inside of the closed end 60. When the tube is pierced before the filtration step, the recess allows the piercing device 62 to completely penetrate the test tube material without disturbing the filtering means 64. FIG. 6 shows an alternative embodiment test tube or vessel 70 in which the filtering means 72 is only partially inserted into the test tube. The filtering means is formed into a cup shape, which serves to wedge the filtering means against the sides of the test tube, thereby keeping the filtering means in position. The space 74 between the filtering means and the closed end 76 of the test tube allows the piercing device to completely penetrate the test tube material without disturbing the filtering means. Of course, in alternate embodiments, the filtering means is disturbed.

FIG. 7 shows an alternative embodiment test tube or vessel 80 in which the filtering means comprises two separate layers 82a and 82b. If the piercing device 84 should penetrate too deeply into the tube and contact the filtering means, the lower layer 82a acts as a protective buffer to prevent the upper layer 82b from being disturbed.

In further alternate embodiments of the invention, the filtering means are substances or chemicals which serve to filter or retain or provide other processing as will occur to those of ordinary skill in the art. In even further embodiments, filtering means are omitted entirely or substances added to accomplish other types of processing such as precipitation, digestion, or other chemical reactions or processing as will occur to those of ordinary skill in the art. In still further embodiments, filtering means is a property of the vessel.

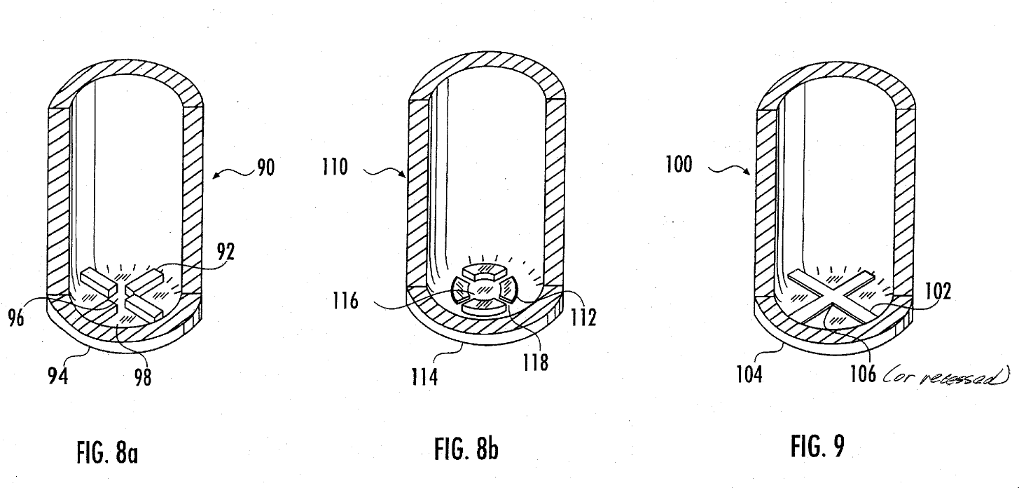

FIG. 8a shows an alternative embodiment test tube or vessel 90 having integral linear supporting means 92 which are disposed radially from the center of the closed end 94 of the tube or vessel. The supporting means offset the filtering means (not shown) from the closed end. The space 96 which separates the center of closed end and the filtering means allows the piercing device to completely penetrate the test tube material without disturbing the filtering means. The spaces such as 98 between the supporting means provide flow paths for the liquid and waste products, thereby decreasing the time required for the filtration step.

FIG. 8b shows an alternative embodiment test tube 110 or vessel having integral arcuate supporting means such as 112 which are disposed circularly around the center of the closed end 114 of the tube. The supporting means offset the filtering means (not shown) from the closed end. The space 116 which separates the center of closed end and the filtering means allows the piercing device to completely penetrate the test tube material without disturbing the filtering means. The spaces such as 118 between the supporting means provide flow paths for the liquid and waste products, thereby decreasing the time required for the filtration step. In other embodiments the integral supports are in any suitable shape, form, or number. Again, in alternate embodiments, the filter is disturbed by the piercing and still provides a useful result.

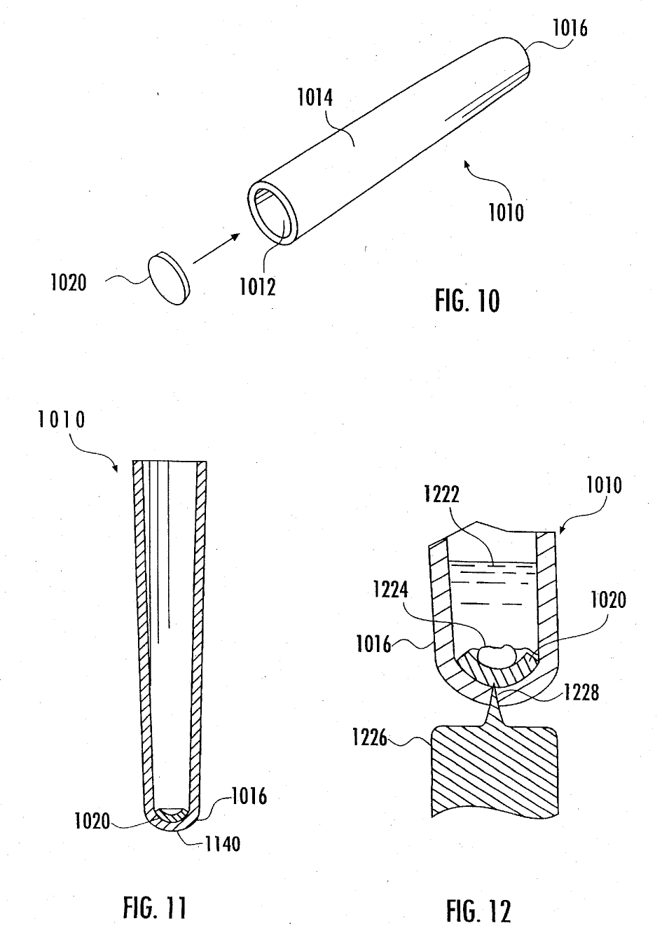

FIG. 9 shows an alternative embodiment test tube or vessel 100 having grooves 102 disposed on the inside of the closed end 104 of the test tube or vessel. The space 106 which separates the center of closed end and the filtering means (not shown) allows the piercing device to completely penetrate the test tube material without disturbing the filtering means. The grooves provide flow paths for the liquid and waste products, thereby decreasing the time required for the filtration step. In other embodiments the grooves have in any suitable shape, form or number.

In a further embodiment of the present invention, a tube or vessel for preparing fluid samples is provided. The tube or vessel comprises a hollow body. In one embodiment the vessel has an open end and a closed end. In another embodiment, the vessel has no ends or is entirely enclosed. In a further embodiment, the vessel comprises and a filtering means for selectively retaining a desired substance from a sample fluid. The filtering means is disposed in the body proximate to the closed end of the tube.

In an even further embodiment, filter paper is formed into a cup. In a further embodiment, the filtering means comprises two or more layers of filter paper. In a further embodiment, the filter paper comprises glass fibers.

In a further embodiment, the tube further comprises a gap interposed between the filtering means and the closed end of the tube. In an even further embodiment, the gap is maintained by supporting means for supporting the filtering means. In a further embodiment, the supporting means comprises one or more linear projections disposed radially from the center of the closed end of the tube. In an even further embodiment, supporting means comprises one or more arcuate projections disposed circularly around the center of the closed end of the tube. In still a further embodiment, the tube comprises a recess disposed on the inside of the closed end of the tube. In a further embodiment, the recess is located generally in the center of the closed end of the tube. In a further embodiment, the recess comprises one or more grooves, the grooves passing generally through the center of the closed end of the tube.

Turning now to a further example embodiment, a method for processing substances in a single container is provided. In the current example embodiment, a glass fiber filter is inserted into a standard plastic test tube or vessel. One example of a suitable glass fiber filter paper that would occur to one of ordinary skill in the art Whatman Cat. #09-874-40A. Referring to FIG. 10, the test tube or vessel 1010 has an open end 1012 and a thin-walled cylindrical body 1014 which tapers to a spherical closed end 1016. The filter 1020 is a thin, circular disc of glass fiber paper that can be cut or stamped from a sheet or continuous roll of material. Referring to FIG. 11, once the filter 1020 is fully inserted into the test tube 1010, and positioned with a slight gap between the filter 1020 and the closed end 1016 of the tube 1010. This gap 1140 helps to prevent sample materials and fluid to pass more reliably through the filter paper 1020 during later steps. Next, in a further example embodiment, 170 micro-liters of a first reagent is aspirated into a Hydra. The first reagent can be any substance which promotes the aggregation and precipitation of the substance sought to be isolated. One example of a suitable first reagent is a polyethylene glycol solution (PEG) composed of the following reagents in the following proportions: 200 gm PEG (Sigma Cat. # P-2139); 146 gm NaCl; QS to 1000 ml with sterile H₂O.

Prior to aspirating the PEG solution an M13 bacterial culture is incubated in a separate test tube, vessel or other similar sample container. The samples are then centrifuged to remove cells and debris. The preceding method of preparing M13 cultures is well known, and a detailed disclosure is not considered necessary to describe the present invention. Next, in one example embodiment, 400 micro-liters of the centrifuged supernatant containing M13 phage DNA is aspirated into the Hydra containing the first reagent (in this case PEG). The mixture of supernatant and PEG is transferred from the Hydra to the tube or vessel containing the filter paper. The supernatant and the PEG solution are then thoroughly mixed by repeating a cycle of aspirate and dispense three times to form a well-mixed solution of supernatant and PEG. This mixture is then incubated at 4 deg. C. for 30 minutes.

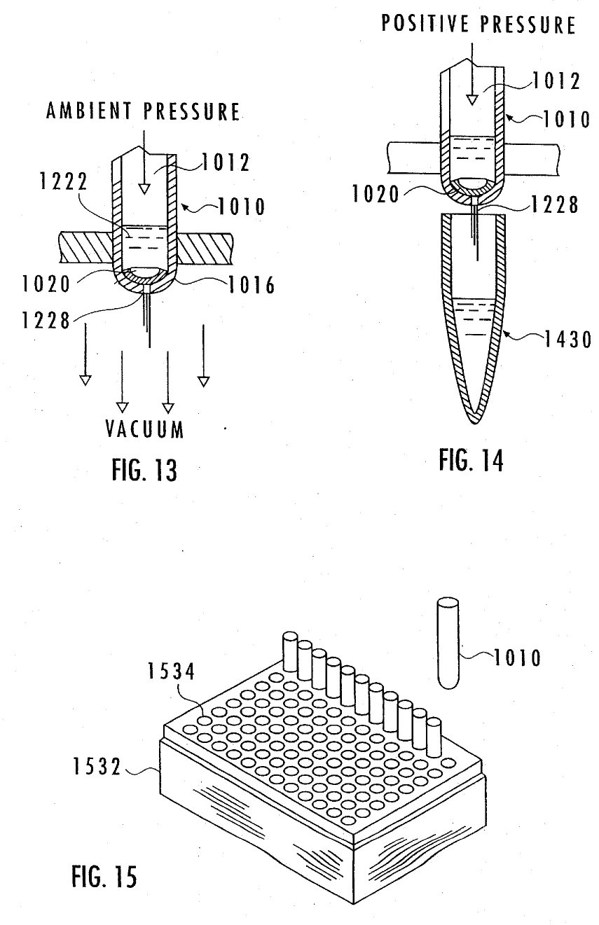

After the incubation, in a further embodiment, the mixture is centrifuged in the same test tube, or vessel, to pellet the phage in the closed end of the tube. However, it should be noted that in other example embodiments, such as when processing plasmids or other biological substances, centrifugation is optional. As shown in FIG. 12, the test tube 1010 now contains the filter 1020, the supernatant fluid 1222, and the pelleted phage 1224. Next, the closed end of the tube or vessel 1016 is pierced to create an aperture 1228 by a blade, needle 1226 or any other device capable of creating an aperture. The travel of the blade or needle 1226 is limited so that the blade or needle 1226 completely penetrates the wall of the test tube 1010 but does not completely penetrate the filter 1020. In this example embodiment, the aperture 1228 is sized such that gravity driven leakage occurs at a sufficiently slow rate to allow the reactions in the following operations to occur before the fluid is lost. Referring to FIG. 13, a vacuum is then applied to the closed end 1016 of the test tube 1010, while the open end 1012 of the tube 1010 is exposed to ambient pressure. The resulting pressure differential across the aperture 1228 forces the supernatant fluid 1222 to flow through the filter 1020 and out of the tube through the aperture.

Next, a second reagent is added to the tube or vessel, in the present embodiment this is done to dissociate the phage proteins from the DNA and a volume of approximately 5.2 milliliters is added. An example second reagent could be any de-kaotropic salt solution such as a 6.5M sodium per-chlorate solution composed of the following reagents in the following proportions: 456.63 gm Sodium Perchlorate (Sigma Cat. #51401-500G); 5 mls of 1 M tris-HCL (pH 8.0); 100 micro-liters of 0.5 M EDTA (pH 8.0); QS to 500 mls with sterile H₂O. Next, a vacuum is again applied to the closed end of the tube to remove the Sodium Perchlorate solution. The DNA is now bound to the filter. Next, a third reagent is added to the tube or vessel, to wash the excess proteins, salts and other debris from the filter-bound DNA. One example of a suitable third reagent is a 75% Ethanol solution composed of the following reagents in the following proportions: 525 ml of 100% Ethanol (200 proof AAPER Alcohol & Chemical Co., DSP-KY 417); 175 ml sterile H₂O. Next, a vacuum is applied to remove the ethanol, in a manner similar to the previous steps.

Next, a fourth reagent is added to the tube. One example of a suitable fourth reagent is any substance that comprises a biological suspension buffer and a divalent cation scavenger such as TE buffer. A suitable quantity for the example TE buffer is 45 micro-liters and comprises the following reagents: Tris(hydroxymethyl) aminomethane (TRIS) and ethylenediaminetetraacetic acid (EDTA). Referring to FIG. 14, next a positive pressure is applied to the open end 1012 of the tube or vessel 1010 to elute the DNA into a sample container 1430. The pressure differential across the aperture 1228 forces the eluted DNA from the filter 1020, through the aperture, and into the container 1430. The purified DNA is ready for further amplification, sequencing, testing, or storage. The tube or vessel assembly is discarded.

Various embodiments of the present invention involve the dispensing of fluid into a test tube or vessel. Each of these embodiments can be accomplished using a hand held pipetter, an automated fluid dispenser, or any other suitable method of dispensing a controlled amount of fluid or any other suitable method of transferring fluid from one vessel to another. In a further embodiment, the mixing of the tube contents is done using a reciprocating or vortexing mechanical mixer. In a still further embodiment, the mixing is also done with a hand held pipetter or other means of mixing that will occur to those of ordinary skill in the art.

Many of the steps and operations of the prior art methods are carried out in a multiple tube format. Some examples of the multiple tube formats are the standard 96-well or 384-well format, the test tubes, filter plates, collection wells, and other components are arranged in an 8×12 or 16×24 array. The size of the trays and holders are standardized, and many centrifuges, dryers, fluid dispensers and automatic pipetting machines are designed to be compatible with this format. In various embodiments of the present invention, some or all of the steps are accomplished using a multiple tube format to facilitate the use of the machines listed above. Of course, in alternate embodiments, nonstandard tray and holder sizes are used. FIG. 15 shows test tubes such as 1010 being inserted into a tube carrier 1532 having holes 1534 which may be arranged in an 8×12 array or other suitable format. In an alternate embodiment, the vessel and carrier are a single unit. In one embodiment, this single unit may be a vessel which has been permanently attached to a carrier. Or in an even further embodiment, a single molded carrier is provided incorporating shaped recesses which provide two or more vessels.

In a further embodiment of the present invention, the filters are inserted by hand, or by an automated machine designed for that purpose. Such a machine could also be adapted to punch the filter from a sheet or roll of material, and insert them into the test tubes in a single step. In alternative embodiments, the filter can be replaced by any means which will selectively and releasably retain the desired substance and the waste products. Other alternative embodiments eliminate the filter entirely and only involve substances added in any of the processing steps.

In alternate embodiments, piercing of the test tube or vessel is done one tube or vessel at a time or in a multiple tube or vessel format. In various embodiments, the cutting force is supplied by hand using an arbor press, by fluid powered cylinders, or by any other suitable means of providing force. In an even further embodiment, the loading and unloading of the tubes and cutting operation itself is automated. In still other embodiments the tube is made of any material, and the aperture created my any suitable means.

In still further embodiments, the method of the present invention includes the additional step of temporarily sealing the open end of the test tube to prevent gravity driven fluid flow through the aperture. In some embodiments, the aperture is sized such that the surface tension of the fluid within the aperture is sufficient to prevent leakage through the aperture.

Various steps of the example embodiments of the invention, involve forcing fluid through the aperture in the test tube under the influence of a pressure differential across the aperture. In various embodiments, vacuum, positive pressure, or any other method that will occur to those of ordinary skill in the art is used in any of these steps to create the necessary pressure differential. In other embodiments, any suitable means that will occur to those of ordinary skill in the art such as inertia or centrifugal force are used to force the fluid to exit the test tube. In still a further embodiment, the elution of substances such as DNA, RNA or other desired substances as will occur to those of ordinary skill in the art is also accomplished by centrifugation.

In alternative embodiments, the method of the present invention is used in any application where a desired substance is sought to be isolated, extract, or otherwise processed from a sample substance, solid, plasma or gas, containing the desired substance and one or more waste substances. In various alternate embodiments, a desired substance is a protein, DNA, RNA, or any other macromolecule or combination thereof that will occur to those of ordinary skill in the art. In some instances, it may not be necessary to pellet the precipitate. In another embodiment, the tube would be pierced before the filter is inserted, and in further embodiments the tube piercing could be combined with filter insertion in a single step.

As discussed above, there are a number of means available to perform the various steps of the present invention. In other embodiments, some or all of the steps of the present invention are accomplished by an automated machine with or without human intervention. It is intended that this invention include all possible combinations and permutations of these means which accomplish the respective steps of the method disclosed.

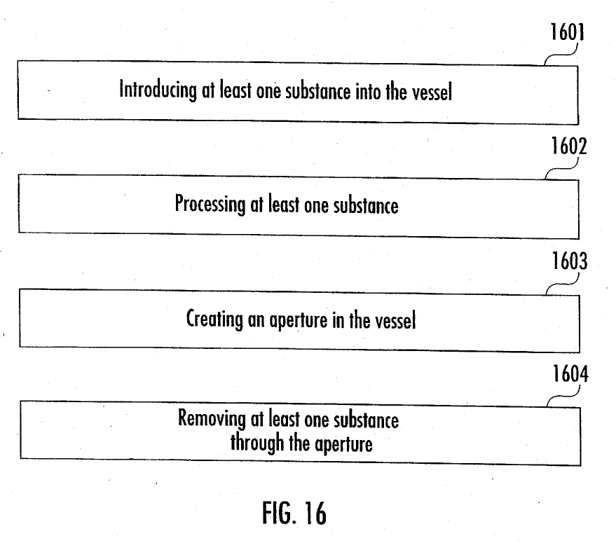

Turning now to FIG. 16, in an even further embodiment of the present invention, a method for processing at least one substance in a vessel capable of retaining at least one substance is provided. The method comprises introducing (1601) the at least one substance into the vessel. The method further comprises processing (1602) the at least one substance. The method further comprises creating (1603) an aperture in the vessel and removing (1604) at least one substance through the aperture.

In an even further embodiment, the vessel has an opened end and a closed end.

In a further embodiment, the method further comprises inserting a filtering means. In a further embodiment, wherein a filtering means retains one or more substances introduced into the vessel. In another embodiment, the at least one substance further comprises a filter.

In an even further embodiment, the aperture in the vessel is created generally in the closed end. In various embodiments, the vessel is made of plastic, rubber thermoplastic material or any other material that can be pierced in accordance with the present invention as will occur to those of ordinary skill in the art.

In a further embodiment, the vessel is a test tube, cylinder, sphere, cup, cavity, recessed surface, rectangular cavity, or any other suitable vessel that will occur to one of ordinary skill in the art. In an even further embodiment, the vessel may have no open ends or be totally enclosed.

In a further embodiment, the creating an aperture further comprises piercing the vessel. In a further embodiment, piercing further comprises forcing a generally cylindrical member having a sharp point through the body of the vessel. In a further embodiment, piercing further comprises forcing a generally wedge shaped member any other suitable piercing device through the body of the vessel as will occur to one of ordinary skill in the art. In still further embodiments, aperture is created by locally melting, fracturing, vaporizing, chemically reacting or any other suitable means of creating an aperture that will occur to those of ordinary skill in the art.

In still a further embodiment, the aperture is sufficiently small to substantially prevent gravity driven flow of fluid through the aperture. In a further embodiment, the method further comprises the step of sealing the open end of the test tube to prevent unwanted fluid flow through the aperture.

In a further example embodiment, a method of isolating a desired substance from a sample substance containing the desired substance and waste substances is provided. The method comprises inserting into a test tube a filtering means or substance for releasably and selectively retaining the desired substance and the waste substances. The method also comprises adding to the test tube, in any order, (i) the sample substance and (ii) a first reagent. The method comprises mixing the sample substance and the first reagent to form a processed sample substance and a precipitate containing the desired substance and the waste substances. The method comprises forcing the precipitate toward an end of the test tube. In alternate embodiments, that end will be the closed end or the open end. The method also comprises creating an aperture in the closed end of the test tube. The method comprises causing the processed sample substance to exit the test tube through the aperture, such that the processed sample fluid passes through the filtering means, and the precipitate is retained on the filtering means. The method also comprises adding a second reagent, if a second reagent is necessary or desirable, to the test tube. The filtering means selectively releases the waste substances and selectively retains the desired substance when the first or second reagent contacts the filtering means. The method also comprises causing the second reagent and the waste substances to exit the test tube through the aperture. The method comprises adding a third reagent, if a third reagent is necessary or desirable, to the test tube. The third reagent removes traces of the second reagent from the filtering means. The method also comprises causing the third reagent and the traces of the second reagent to exit the test tube through the aperture. The method comprises adding a fourth reagent, if the fourth reagent is necessary or desirable, to the test tube. The filtering means releases the desired substance when the fourth reagent contacts the filtering means. The method comprises causing the fourth reagent and the desired substance to exit the test tube through the aperture. The fourth or in this example embodiment, the final reagent and desired substance flows directly into a sample container through the aperture. As will occur to those of ordinary skill in the art, the possibility of four iterations or reagents is shown in this example embodiment. In various alternate embodiments, any number or sequence of iterations of processes or number of reagents are used to wash, retain, dilute or process in some manner to produce desired results. In an even further embodiment, the desired substance is not caused to exit the tube. Instead, the substance is retained.

In a further embodiment, the filtering means comprises a glass fiber filter, filter, bead, glass bead, gel, silica gel, surface of the vessel, or any other substrate or substance that will occur to those of ordinary skill in the art. In other example embodiments, diatomaceous earth is used. In one example embodiment Celatom, FW-30, made by ACROS, is used.

In a various embodiments, the desired substance comprises macro-molecules, bio-molecules, proteins, nucleic acid, or any other desired substance that will occur to those of ordinary skill in the art.

In a further embodiment, the sample substance comprises the supernatant from a centrifuged bacterial culture.

In still a further embodiment, the first reagent promotes aggregation and precipitation of the desired substance. In a further embodiment, the first reagent comprises a PEG solution. In an even further embodiment, the mixing the sample substance and the first reagent is accomplished by rapid cyclic motion of the test tube. In a further embodiment, the aspiration and dispensing of the substances any other method of mixing as will occur to those of ordinary skill in the art.

In a further embodiment, processed sample fluid is caused to exit the test tube by creating a pressure differential across the aperture, the pressure differential being sufficient to force the processed sample fluid through the aperture. In a further embodiment, the pressure differential is created by applying a vacuum to the closed end of the test tube.

In a various embodiments, the second reagent, if necessary or desirable, comprises a dekaotropic salt solution, a sodium per-chlorate solution, or any other reagent that will occur to those of ordinary skill in the art. In a further embodiment, the second reagent, if necessary or desirable, and the waste substances are caused to exit the test tube by creating a pressure differential across the aperture, the pressure differential being sufficient to force the second reagent and the waste substances through the aperture.

In a further embodiment, the third reagent, if necessary or desirable, comprises an ethanol solution. In a further embodiment, the third reagent, if necessary or desirable, and the traces of the second reagent, if necessary or desirable, are caused to exit the test tube by creating a pressure differential across the aperture, the pressure differential being sufficient to force the third reagent and the traces of the second reagent through the aperture.

In a various embodiments, forth reagent, if necessary or desirable, comprises a biological suspension buffer and a divalent cation scavenger, a TE buffer, or any other reagent that will occur to those of ordinary skill in the art.

In a further embodiment, the fourth reagent, if necessary or desirable, and the desired substance are caused to exit the test tube by centrifuging. In a further embodiment, the fourth reagent, if necessary or desirable, and the desired substance are caused to exit the test tube by creating a pressure differential across the aperture, the pressure differential being sufficient to force the fourth reagent, if necessary or desirable, and the desired substance through the aperture. In a further embodiment, the pressure differential is created by applying positive pressure to the open end of the test tube.

In an even further embodiment, at least one of the steps is preformed on a plurality of test tubes or vessels simultaneously. In a further embodiment, the test tubes or vessels are arranged in a rectangular array. In a further embodiment, the rectangular array comprises eight rows, each the row comprising twelve test tubes.

In a further embodiment, at least one of the steps is automatically controlled. In an alternate embodiment, all of the steps are automatically controlled.

In a further embodiment, the method comprises creating an aperture in a closed end of the test tube or vessel before forcing the precipitate towards the end of the tube or vessel.

While, for the purposes of disclosure there have been shown and described what are considered at present to be example embodiments of the present invention, it will be appreciated by those skilled in the art that other uses may be resorted to and changes may be made to the details of construction, combination of shapes, size or arrangement of the parts, or other characteristics without departing from the spirit and scope of the invention. It is therefore desired that the invention not be limited to these embodiments and it is intended that the appended claims cover all such modifications as fall within this spirit and scope.

While, for the purposes of disclosure there have been shown and described what are considered at present to be example embodiments of the present invention, it will be appreciated by those skilled in the art that other uses may be resorted to and changes may be made to the details of construction, combination of shapes, size or arrangement of the parts, or other characteristics without departing from the spirit and scope of the invention. It is therefore desired that the invention not be limited to these embodiments and it is intended that the appended claims cover all such modifications as fall within this spirit and scope.

Moreover, in a further embodiment, a tube is provided for preparing fluid samples, the tube including at least: a hollow, cylindrical body having an open end and a closed end; and a filtering means for selectively retaining a desired substance from a sample fluid, the filtering means being disposed in the body proximate to the closed end of the tube.

In a further embodiment, a method is provided for processing at least one biological substance in a vessel capable of retaining at least one substance, the method including at least: introducing the at least one substance into the vessel; inserting a filtering means separate from said introducing; processing the at least one substance; creating a non-self-sealing aperture in the vessel after said introducing; and removing at least one substance through the aperture.

In another example embodiment of the method, the filtering means includes at least a filter.

In another example embodiment of the method, the filtering means further includes at least a retaining substance.

In another example embodiment of the method, the vessel is a test tube.

In another example embodiment of the method, the creating an aperture further comprises piercing the vessel.

In another example embodiment of the method, the method further includes at least the step of sealing the open end of the test tube to prevent unwanted fluid flow through the aperture.

In a further embodiment, a method is provided for processing substances in a container, with the container including at least one closed end, the method including at least: introducing at least one desired substance into the container; introducing at least one reagent into the container; creating an aperture in the at least one closed end; and retaining at least a part of the desired substance in the container after the aperture is created.

In another example embodiment of the method, the processing further comprises purification of DNA.

In another example embodiment of the method, the processing further comprises purification of RNA.

In another example embodiment of the method, the processing further comprises purification of proteins.

In another example embodiment of the method, the processing further comprises purification of bio-molecules.

In another example embodiment of the method, the at least one desired substance further comprises DNA.

In another example embodiment of the method, the at least one desired substance further comprises RNA.

In another example embodiment of the method, the at least one desired substance further comprises proteins.

In another example embodiment of the method, the at least one desired substance further comprises bio-molecules.

In another example embodiment of the method, the at least one desired substance further comprises oligonucleotides.

In another example embodiment of the method, the at least one desired substance further comprises organic molecules.

In another example embodiment of the method, the at least one reagent comprises a chaotropic substance.

In another example embodiment of the method, the at least one reagent comprises sodium per-chlorate.

In another example embodiment of the method, the at least one reagent comprises a macromolecular crowding agent.

In another example embodiment of the method, the at least one reagent comprises a polar liquid.

In another example embodiment of the method, the at least one reagent comprises an alcohol.

In another example embodiment of the method, the at least one reagent comprises a lysis buffer.

In another example embodiment of the method, the at least one reagent comprises a wash buffer.

In another example embodiment of the method, the creating an aperture further comprises piercing.

In another example embodiment of the method, the retaining further comprises adsorption.

In another example embodiment of the method, the retaining further comprises absorption.

In another example embodiment of the method, the retaining further comprises filtering.

In another example embodiment of the method, the retaining further comprises filtering chemically.

In another example embodiment of the method, the filtering chemically further comprises precipitating.

In another example embodiment of the method, the filtering chemically further comprises digesting.

In another example embodiment of the method, the retaining further comprises filtering physically.

In another example embodiment of the method, the filtering physically further comprises filtering with a glass fiber filter.

In another example embodiment of the method, the filtering physically further comprises filtering with a bead.

In another example embodiment of the method, the bead comprises a glass bead.

In another example embodiment of the method, the retaining further comprises filtering with a silica gel.

In another example embodiment of the method, the method further includes removing excess fluid from the container.

In another example embodiment of the method, the removing excess fluid from the container further comprises removing excess fluid through the aperture created.

In another example embodiment of the method, the removing the excess fluid further comprises vacuuming.

In another example embodiment of the method, the method further includes at least: adding a supernatant; and precipitating the desired substance.

In another example embodiment of the preceding method, the method further includes at least pelleting the phage.

In another example embodiment of the preceding method, the method further includes at least adding a sodium per-chlorate solution to the container.

In another example embodiment of the preceding method, the method further includes at least adding an ethanol solution to the container.

In another example embodiment of the preceding method, the method further includes at least eluting the substances within the container.

In another example embodiment of the preceding method, the eluting further comprises applying positive pressure to at least one end of the container.

In another example embodiment of the method, the container comprises a test tube.

In a further embodiment, a method is provided for processing substances in a container, with the container including at least one closed end, the method including at least: introducing at least one desired substance into the container; introducing at least one reagent into the container; creating an aperture in the at least one closed end; and retaining at least a part of the desired substance in the container after the aperture is created.

In a further embodiment, a method is provided for processing biological substances in a container, the container including at least one closed end and at least one open end, the method including at least: introducing a retaining substance into an open end of the container; introducing at least one desired substance into the container separate from said introducing said retaining substance; creating an aperture in the at least one closed end of the container after said introducing at least one desired substance through said open end; and retaining at least part of the desired substance in the container after the aperture is created.

In another example embodiment of the method, the creating an aperture further comprises piercing.

In another example embodiment of the method, the retaining further comprises adsorption.

In another example embodiment of the method, the retaining further comprises absorption.

In another example embodiment of the method, the retaining further comprises filtering.

In another example embodiment of the method, the retaining substance further comprises a filter.

In a further embodiment, a method is provided for extracting a desired substance from other substances within a container, the method including at least: pelletting the desired substance; piercing the container; evacuating the container of at least one undesired substance; retaining the desired substance; and eluting the desired substance.

In a further embodiment, a system is provided for processing substances in a container, the container comprising at least one closed end, the system including at least: means for creating an aperture in the at least one closed end; and means for retaining at least a part of the desired substance in the container after the aperture is created.
In another example embodiment of the system, the means for creating an aperture further comprises means for piercing.

In another example embodiment of the system, the means for retaining further comprises means for adsorption.

In another example embodiment of the system, the means for retaining further comprises means for absorption.

In another example embodiment of the system, the means for retaining further comprises means for filtering.

In another example embodiment of the system, the means for retaining further comprises means for filtering chemically.

In another example embodiment of the preceding system, the means for filtering chemically further comprises means for precipitating.

In another example embodiment of the preceding system, the means for filtering chemically further comprises means for digesting.

In another example embodiment of the system, the means for retaining further comprises means for filtering physically.

In another example embodiment of the preceding system, the means for filtering physically further comprises means for filtering with a glass fiber filter.

In another example embodiment of the preceding system, the means for filtering physically further comprises means for filtering with a bead.

In another example embodiment of the preceding system, the bead comprises a glass bead.

In another example embodiment of the system, the means for retaining further comprises means for filtering with a silica gel.

In another example embodiment of the system, the system further includes at least means for removing excess fluid from the container.

In another example embodiment of the preceding system, the means for removing excess fluid from the container further comprises means for removing excess fluid through an aperture created by the piercing.

In another example embodiment of the preceding system, the means for removing the excess fluid further comprises means for vacuuming.

In another example embodiment of the system, the container comprises a test tube.

In a further embodiment, a vessel is provided for processing substances, the vessel including at least: a hollow body comprising at least one closed end; the at least one closed end being pierceable to allow fluid to flow when pierced; and a retaining substance for selectively retaining a desired substance from the fluid.

In another example embodiment of the vessel, the retaining substance further comprises filter.

In another example embodiment of the vessel, the retaining substance further comprises filter paper.

In another example embodiment of the preceding vessel, the filter paper is formed into a cup.

In another example embodiment of the vessel, the retaining substance further comprises fibers.

In another example embodiment of the vessel, the retaining substance further comprises glass.

In another example embodiment of the vessel, the retaining substance further comprises solid phase extraction media.

In another example embodiment of the vessel, the retaining substance further comprise beads.

In another example embodiment of the vessel, the retaining substance further comprises silica.

In another example embodiment of the vessel, the retaining substance further comprises a gel.

In another example embodiment of the vessel, the retaining substance further comprises surface coating.

In another example embodiment of the vessel, the vessel further includes at least a gap interposed between the retaining substance and the closed end of the vessel.

In another example embodiment of the preceding vessel, the gap is maintained by supporting means for supporting the retaining substance.

In another example embodiment of the preceding vessel, the supporting means comprises one or more linear projections disposed radially from the center of the closed end of the vessel.

In another example embodiment of the preceding vessel, the supporting means comprises one or more arcuate projections disposed circularly around the center of the closed end of the vessel.

In another example embodiment of the vessel, the vessel further includes at least a recess disposed on the inside of the closed end of the vessel.

In another example embodiment of the preceding vessel, the recess is located generally in the center of the closed end of the vessel.

In another example embodiment of the preceding vessel, the recess comprises one or more grooves, the grooves passing generally through the center of the closed end of the vessel.

In a further embodiment, a test tube is provided for processing substances, the test tube including at least: a first end; a second end; a hollow body; the first end comprising an open end; and the second end comprising: a pierce-able closed end; a raised interior surface; and a recessed interior surface.

In another example embodiment of the test tube, the raised interior surface comprises a raised cross-shaped surface.

In another example embodiment of the test tube, the recessed interior surface comprises a raised cross-shaped surface.

In another example embodiment of the test tube, the raised interior surface comprises a raised circular-shaped surface.

In another example embodiment of the test tube, the recessed interior surface comprises a recessed circular-shaped surface.

In another example embodiment of the test tube, the pierce-able closed end further comprises a weakened closed end.

In another example embodiment of the test tube, the pierce-able closed end is more penetrable than the body.

In a further embodiment, a method is provided for isolating a single type of molecule from a biological sample comprising an unisolated form of said type of molecule, the method including at least: introducing said sample into a container having at least one closed end; introducing a retaining substance separate from said introducing said sample; separating said single type of molecule from the sample; whereby at least two substances are separated; creating an aperture in the at least one closed end of the container, after said introducing said sample; and removing at least one of said at least two substances through said aperture.

In a further embodiment, a method is provided for processing at least one biological substance in a vessel capable of retaining at least one substance, the method including at least: introducing the at least one substance into the vessel; inserting a filtering means separate from said introducing; processing the at least one substance; creating a non-self-sealing aperture in the vessel after said introducing; and removing at least one substance through the aperture.

In another example embodiment of the method, the biological substance includes at least blood.

In another example embodiment of the method, the biological substance includes at least bacteria.

In another example embodiment of the method, the biological substance includes at least tissue.

In another example embodiment of the method, the biological substance includes at least cells.

In another example embodiment of the method, the biological substance includes at least proteins.

In another example embodiment of the method, the biological substance includes at least nucleic acids.

In another example embodiment of the method, the biological substance includes at least carbohydrates.

In another example embodiment of the method, the biological substance includes at least lipids.

In another example embodiment of the method, the biological substance includes at least antibodies.

In another example embodiment of the method, the biological substance includes at least enzymes.

In another example embodiment of the method, the biological substance includes at least bio-reactive molecules.

In a further embodiment, a method is provided for processing biological substances in a container, the container comprising at least one closed end and at least one open end, the method including at least: introducing a retaining substance into an open end of the container; introducing at least one desired substance into the container separate from said introducing said retaining substance; creating an aperture in the at least one closed end of the container after said introducing at least one desired substance through said open end; and retaining at least part of the desired substance in the container after the aperture is created.

In another example embodiment of the method, the biological substance includes at least blood.

In another example embodiment of the method, the biological substance includes at least bacteria.

In another example embodiment of the method, the biological substance includes at least tissue.

In another example embodiment of the method, the biological substance includes at least cells.

In another example embodiment of the method, the biological substance includes at least proteins.

In another example embodiment of the method, the biological substance includes at least nucleic acids.

In another example embodiment of the method, the biological substance includes at least carbohydrates.

In another example embodiment of the method, the biological substance includes at least lipids.

In another example embodiment of the method, the biological substance includes at least antibodies.

In another example embodiment of the method, the biological substance includes at least enzymes.

In another example embodiment of the method, the biological substance includes at least bio-reactive molecules.

While, for the purposes of disclosure there have been shown and described what are considered at present to be example embodiments of the present invention, it will be appreciated by those skilled in the art that other uses may be resorted to and changes may be made to the details of construction, combination of shapes, size or arrangement of the parts, or other characteristics without departing from the spirit and scope of the invention. It is therefore desired that the invention not be limited to these embodiments and it is intended that the appended claims cover all such modifications as fall within this spirit and scope.

In addition, the design described does not limit the scope of the embodiments of invention; the number of various elements may change, or various components may be added or removed to the above-described concept.

Moreover, the foregoing disclosure and description of embodiments of the invention is illustrative and explanatory of the above and variations thereof, and it will be appreciated by those skilled in the art, that various changes in the design, organization, order of operation, means of operation, equipment structures and location, methodology, the use of mechanical equivalents, such as different components, compositions, reagents, features, and aspects than as illustrated whereby different steps may be utilized, as well as in the details of the illustrated construction or combinations of features of the various elements may be made without departing from the spirit of the embodiments of the invention. As well, the drawings are intended to describe various concepts of embodiments of the invention so that presently preferred embodiments of the invention will be plainly disclosed to one of skill in the art but are not intended to be, for example, manufacturing level drawings or renditions of final products and may include simplified conceptual views as desired for easier and quicker understanding or explanation of embodiments of the invention. As well, the relative size and arrangement of the components may be varied from that shown and the embodiments of the invention still operate and function well within the spirit of the embodiments of the invention as described hereinbefore and in the appended claims. Thus, various changes and alternatives may be used that are contained within the spirit of the embodiments of the invention.

Accordingly, the foregoing specification is provided for illustrative purposes only, and is not intended to describe all possible aspects of the example embodiments of the invention. It will be appreciated by those skilled in the art, that various changes in the ordering of steps, ranges, interferences, spacings, hardware, compositions, and/or attributes and parameters, as well as in the details of the illustrations or combinations of features of the methods and system discussed herein, may be made without departing from the spirit of the embodiments of the invention. Moreover, while various embodiments of the invention have been shown and described in detail, those of ordinary skill in the art will appreciate that changes to the description, and various other modifications, omissions and additions may also be made without departing from either the spirit or scope thereof.

What is claimed is:

1. A tube for preparing fluid samples, the tube comprising:
a hollow, cylindrical body having an open end and a closed end; and
a filtering means for selectively retaining a desired substance from a sample fluid, the filtering means being disposed in the body proximate to the closed end of the tube.

2. A vessel for processing substances, the vessel comprising:
a hollow body comprising at least one closed end;
the at least one closed end being pierceable to allow fluid to flow when pierced; and
a retaining substance for selectively retaining a desired substance from the fluid.

3. The vessel of claim 2, wherein the retaining substance further comprises filter.

4. The vessel of claim 2, wherein the retaining substance further comprises filter paper.

5. The vessel of claim 2, wherein the filter paper is formed into a cup.

6. The vessel of claim 2, wherein the retaining substance further comprises glass.

7. The vessel of claim 2, wherein the retaining substance further comprises solid phase extraction media.

8. The vessel of claim 2, wherein the retaining substance further comprises fibers.

9. The vessel of claim 2, wherein the retaining substance further comprise beads.

10. The vessel of claim 2, wherein the retaining substance further comprises silica.

11. The vessel of claim 2, wherein the retaining substance further comprises a gel.

12. The vessel of claim 2, wherein the retaining substance further comprises surface coating.

13. The vessel of claim 2, further comprising a gap interposed between the retaining substance and the closed end of the vessel.

14. The vessel of claim 13, wherein the gap is maintained by supporting means for supporting the retaining substance.

15. The vessel of claim 14, wherein the supporting means comprises one or more linear projections disposed radially from the center of the closed end of the vessel.

16. The vessel of claim 14, wherein the supporting means comprises one or more arcuate projections disposed circularly around the center of the closed end of the vessel.

17. The vessel of claim 2, further comprising a recess disposed on the inside of the closed end of the vessel.

18. The vessel of claim 17, wherein the recess is located generally in the center of the closed end of the vessel.

19. The vessel of claim 18, wherein the recess comprises one or more grooves, the grooves passing generally through the center of the closed end of the vessel.
